(19) United States
(12) Patent Application Publication
(10) Pub. No.: US 2025/0362164 A1
(43) Pub. Date: Nov. 27, 2025

(54) LIQUID LEVEL MEASUREMENT SYSTEM

(71) Applicant: Bemis Manufacturing Company, Sheboygan Falls, WI (US)

(72) Inventors: Timothy Wilhelm, Sheboygan Falls, WI (US); Jonathan Simpson, Sheboygan Falls, WI (US)

(21) Appl. No.: 19/217,880

(22) Filed: May 23, 2025

Related U.S. Application Data
(60) Provisional application No. 63/651,242, filed on May 23, 2024.

(51) Int. Cl. G01F 23/26

(52) U.S. Cl. CPC G01F 23/261

(57) ABSTRACT

A liquid level measurement system may include a liquid level sensor coupled to an outside of the tank, the liquid level sensor configured to output a sensor signal, and a controller configured to receive the sensor signal from the liquid level sensor and determine whether the liquid within the tank is at a level at or above the liquid level sensor based on the sensor signal.

### CROSS-REFERENCE TO RELATED APPLICATIONS

The present application claims priority to U.S. Provisional Patent Application No. 63/651,242, filed May 23, 2024, the entire content of which is incorporated herein by reference.

### FIELD OF THE DISCLOSURE

The present disclosure relates to liquid level measurement systems for liquid tanks, such as vehicle fuel tanks.

### BACKGROUND OF THE DISCLOSURE

Liquid tanks may include liquid level measurement systems to provide a user an indication of a level of liquid within the tank. Such liquid level measurement systems are typically located inside of the tank or extend into an interior of the tank and may rely on contact with the liquid to provide a signal or indication of the level of the liquid. It may be difficult, however, to obtain an accurate liquid level reading in tanks with irregular geometries. In addition, the liquid within the tank may cause the liquid level measurement system to corrode over time, and the liquid level measurement system may require one or more penetrations through the tank, which can lead to leaks.

### SUMMARY

Accordingly, a need exists for a liquid level measurement system able to reliably measure a level of a liquid within a tank from outside of the tank.

In some aspects, the techniques described herein relate to a liquid measurement system for measuring an amount of liquid within a tank, the liquid measurement system including: a liquid level sensor coupled to an outside of the tank, the liquid level sensor configured to output a sensor signal; a reference sensor coupled to a top portion of the tank on the outside of the tank, the reference sensor configured to output a reference signal; a display; and a controller configured to: receive the sensor signal from the liquid level sensor, receive the reference signal from the reference sensor, compare the sensor signal and the reference signal, and determine whether the liquid within the tank is at a level at or above the liquid level sensor based on the comparison between the sensor signal and the reference signal.

In some aspects, the techniques described herein relate to a liquid measurement system for measuring an amount of liquid within a tank, the liquid measurement system including: a liquid level sensor coupled to an outside of the tank, the liquid level sensor configured to output a sensor signal; and a controller configured to: receive the sensor signal from the liquid level sensor, and determine whether the liquid within the tank is at a level at or above the liquid level sensor based on the sensor signal.

In some aspects, the techniques described herein relate to a liquid measurement system, further including a reference sensor coupled to a top portion of the tank on the outside of the tank, the reference sensor configured to output a reference signal.

In some aspects, the techniques described herein relate to a liquid measurement system, wherein the controller is configured to receive the reference signal from the reference sensor, compare the sensor signal and the reference signal, and determine whether the liquid within the tank is at the level at or above the liquid level sensor based on the comparison between the sensor signal and the reference signal.

In some aspects, the techniques described herein relate to a liquid measurement system, wherein the liquid level sensor is one of a plurality of liquid level sensors spaced along the outside of the tank and configured to output a plurality of sensor signals.

In some aspects, the techniques described herein relate to a liquid measurement system, wherein the controller is configured to receive the sensor signals from the plurality of liquid level sensors and to determine the level of the liquid within the tank by comparing each of the sensor signals with the reference signal.

In some aspects, the techniques described herein relate to a liquid measurement system, the liquid level sensor is a capacitive sensor.

In some aspects, the techniques described herein relate to a liquid measurement system, wherein the reference sensor is a capacitive sensor.

In some aspects, the techniques described herein relate to a liquid measurement system, wherein the plurality of liquid level sensors includes three liquid level sensors.

In some aspects, the techniques described herein relate to a liquid measurement system, wherein the plurality of liquid level sensors is connected to the controller in a daisy chain.

In some aspects, the techniques described herein relate to a liquid measurement system, wherein the liquid level sensor includes an insulative casing extending between the tank and the liquid level sensor.

In some aspects, the techniques described herein relate to a liquid measurement system, wherein the controller is configured to determine whether the liquid within the tank is at the level at or above the liquid level sensor by comparing the sensor signal with a predetermined threshold.

In some aspects, the techniques described herein relate to a liquid measurement system, wherein the controller is configured to determine whether the liquid within the tank is at the level at or above the liquid level sensor by comparing a change in the sensor signal with a predetermined threshold.

In some aspects, the techniques described herein relate to a liquid measurement system, further including a display, wherein the controller is configured to control the display to indicate the level of liquid within the tank based on the determination of whether the liquid within the tank is at the level at or above the liquid level sensor

In some aspects, the techniques described herein relate to a liquid measurement system for measuring an amount of liquid within a tank, the liquid measurement system including: a plurality of liquid level sensors coupled to the tank, each liquid level sensor configured to output a sensor signal corresponding with a measured capacitance of the tank at a position of the liquid level sensor; and a controller configured to: receive the sensor signals from the plurality of liquid level sensors, compare each of the sensor signals with a reference value corresponding with a capacitance of an empty portion of the tank, and determine a level of the liquid within the tank based on the comparison between the sensor signals and the reference value.

In some aspects, the techniques described herein relate to a liquid measurement system, further including a reference sensor coupled to the tank, the reference sensor configured to output a reference signal, wherein the reference value is based on the reference signal.

In some aspects, the techniques described herein relate to a liquid measurement system, wherein the reference sensor is coupled to the tank at a position above a maximum fill level of the tank.

In some aspects, the techniques described herein relate to a liquid measurement system, wherein the plurality of liquid level sensors are connected in a daisy chain.

In some aspects, the techniques described herein relate to a liquid measurement system, wherein the reference value is predetermined and stored in a memory of the controller.

In some aspects, the techniques described herein relate to a liquid measurement system, wherein each liquid level sensor is disposed on an exterior of the tank.

In some aspects, the techniques described herein relate to a liquid measurement system, further including a display, wherein the controller is configured to control the display to indicate the level of liquid within the tank.

Other aspects of the disclosure will become apparent by consideration of the detailed description and accompanying drawings.

### BRIEF DESCRIPTION OF THE DRAWINGS

FIG. 1A is a schematic illustration of a liquid level measurement system according to an embodiment of the present disclosure.

FIG. 1B is a schematic illustration of the liquid level measurement system of FIG. 1A, illustrating a processing unit.

FIG. 2A is a schematic illustration of the liquid level measurement system of FIG. 1A, illustrating a display and a tank at a maximum fill level.

FIG. 2B is a schematic illustration of the liquid level measurement system of FIG. 1A, illustrating a display and a tank at a second liquid level.

FIG. 2C is a schematic illustration of the liquid level measurement system of FIG. 1A, illustrating a display and a tank at a first liquid level.

FIG. 3 is a block diagram of a controller for the liquid level measurement system of FIG. 1A.

FIG. 4 is a flow chart of a first method of operation of the liquid level measurement system of FIG. 1A.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

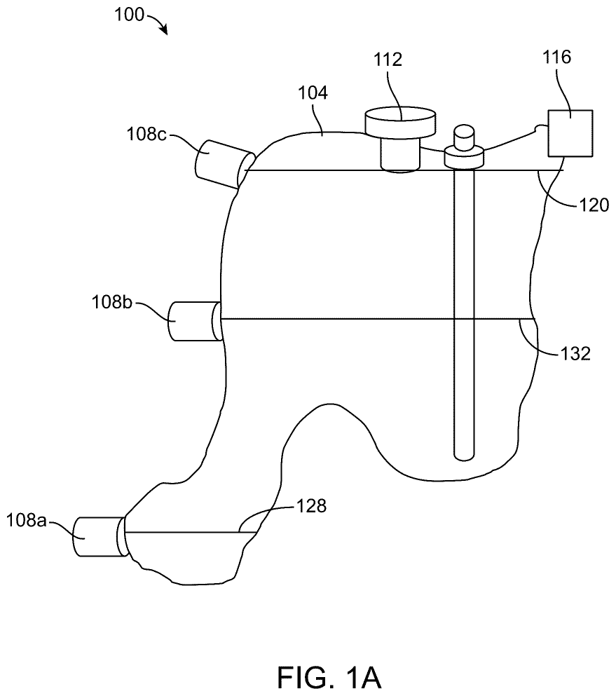

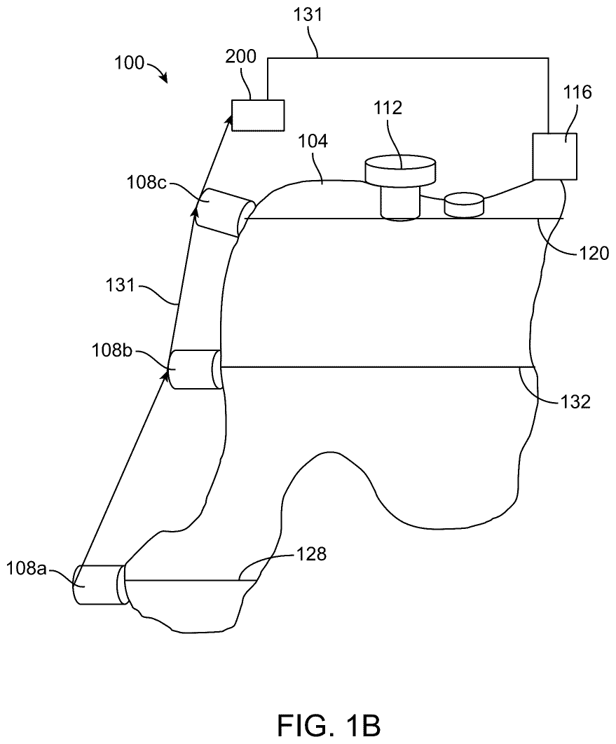

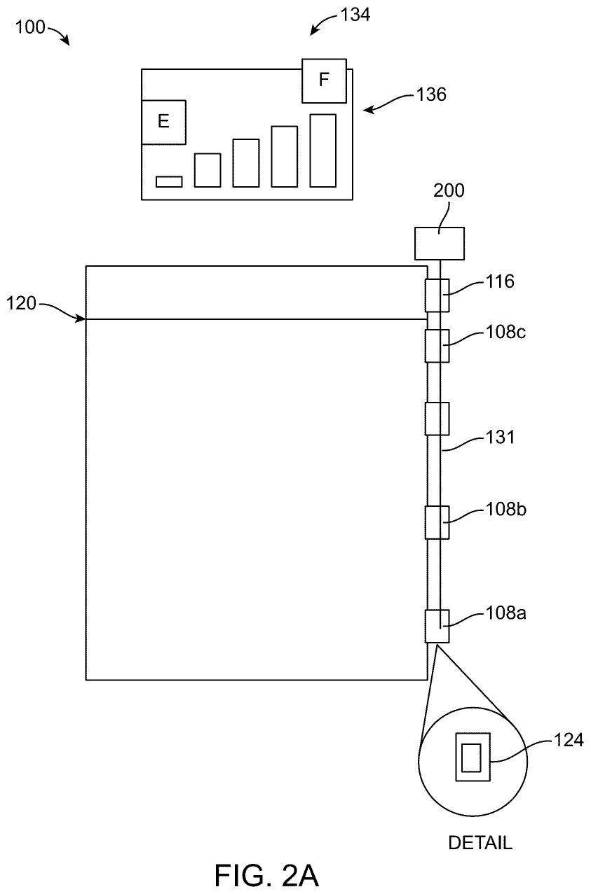

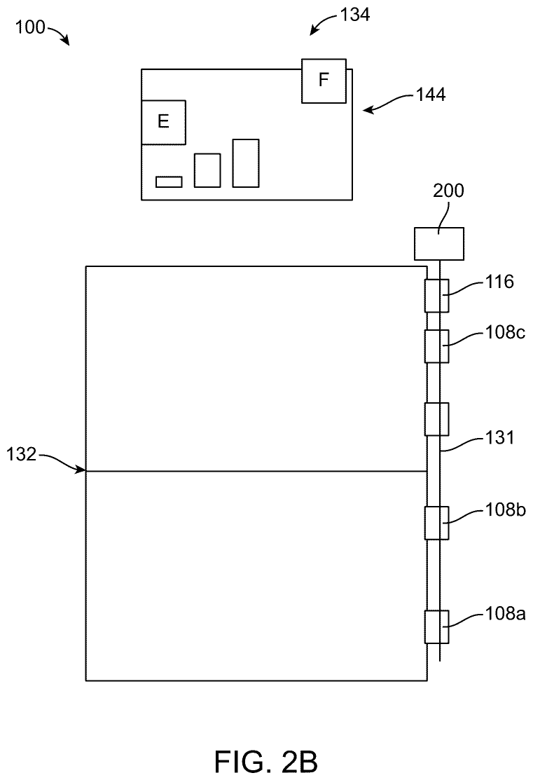

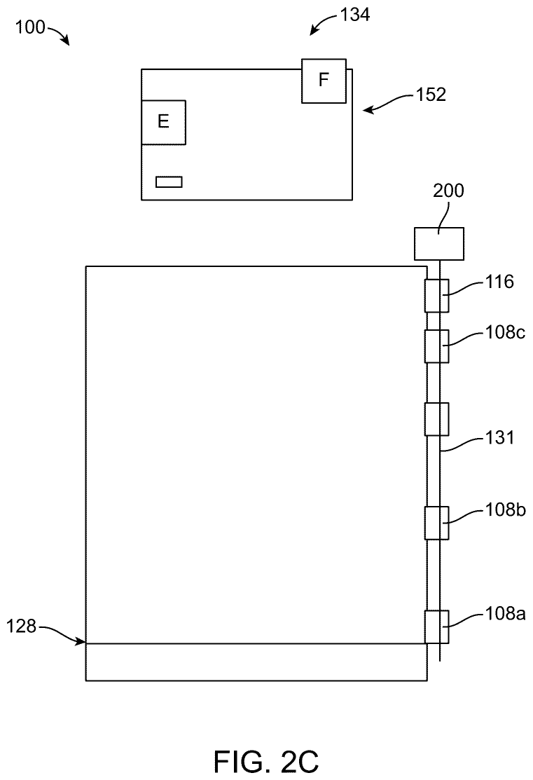

FIGS. 1A-2C illustrate an exemplary embodiment of a liquid level measurement system 100 configured for measuring an amount of liquid within a tank 104. As described in greater detail below, the liquid level measurement system 100 uses a capacitor-based technology. As such, the liquid level measurement system 100 is configured to be attached to an outside of the tank 104, thereby providing a no contact liquid level measuring technique. The no contact liquid level measuring technique avoids exposing the liquid level measurement system 100 to potentially corrosive liquids held by the tank 104, extending the longevity of the liquid level measurement system 100. In addition, existing liquid tanks may be readily retrofitted to include the liquid level measurement system 100.

The illustrated tank 104 is a fuel tank for holding or retaining fuel (e.g., for a vehicle, such as an all-terrain vehicle, an automobile, a lawn tractor, a boat or personal watercraft, a recreational vehicle, etc.). However, the liquid level measurement system 100 may be compatible with any type of tank configured for holding or retaining a liquid. The liquid may include fuel, water, gasoline, DEF, motor oil, coolant, or any other type of liquid. The liquid may range in temperature from 0 degrees Celsius to 100 degrees Celsius. The liquid level measurement system 100 may also be compatible with liquid tanks 104 of various shapes. For example, the tank 104 illustrated in FIGS. 1A and 1B has an irregular shape, such that a typical liquid sensor may inaccurately measure the amount of liquid within the liquid tank. Alternately, the tank 104 may be rectangular in shape (FIGS. 2A-2C). In yet other embodiments, the tank 104 may be cylindrical in shape. The tank 104 may be made of nylon, PE, glass, stainless steel, aluminum, plastic, or other materials of the like. In the present embodiment, the tank 104 is continuous and only includes a liquid orifice 112 configured for receiving the liquid within the tank 104. In other words, the tank 104 does not need to include any holes other than the liquid orifice 112 to permit operation of the liquid level measurement system 100. In other embodiments, the tank 104 may include additional holes.

The illustrated liquid level measurement system 100 includes a plurality of liquid level sensors 108 and a reference sensor 116. The liquid level sensors 108 are spaced vertically along the outside of the tank 104, and the reference sensor 116 is located on the outside of the tank 104 at a top portion of the tank 104 that is above a maximum fill level 120 of the tank 104. The maximum fill level 120 marks the maximum level the liquid within the tank 104 may reach.

The liquid level sensors 108 are positioned such that the tank 104 separates the liquid level sensors 108 from the liquid within the tank 104. The reference sensor 116 is located at an empty region of the tank (e.g., a top portion of the tank, which may contain air, vapor, etc., but not the liquid). As described in greater detail below, in some embodiments, the reference sensor 116 may be omitted. Because the liquid level measurement system 100 is located outside of the tank 104, the liquid level measurement system 100 is not in direct contact with the liquid inside the tank 104. In the present embodiment, the liquid level measurement system 100 has a modular sensor design such that any amount of liquid level sensors 108 may be included in the liquid level measurement system 100 depending on the size of the tank 104 and desired resolution of the system 100. The tank 104 and/or the liquid level sensors 108 include attachment features (e.g., adhesive, epoxy, fasteners, welds, brazing, magnets, etc.) to allow the liquid level sensors 108 to be coupled to the outside of the tank 104 at various heights, each corresponding with a different liquid level. The reference sensor 116 may also include such attachment features. In some embodiments, the liquid level sensors 108 and/or the reference sensor 116 may be integrated into the tank 104 (e.g., at least partially molded within a wall of the tank 104, encased in an overmold, etc.).

With reference to FIG. 2A, in some embodiments, one or more of the liquid level sensors 108 may include an insulative casing 124 surrounding the liquid level sensor 108 and disposed between the liquid level sensor 108 and the wall of the tank 104 to reduce heat transfer between the tank 104 and the liquid level sensor 108. The reference sensor 116 may also include an insulative casing 124 in some embodiments. The insulative casings 124 may protect the sensors 108, 116 during high temperature applications (e.g., when the liquid is high temperature). The insulative casings 124 may further protect the sensors 108, 116 from environmental factors (e.g., debris, weather, etc.). The insulative casings 124 may be made from silicone, with a thickness ranging from ⅛-inch to ¼-inch in some embodiments. In other embodiments, other insulating materials and/or thicknesses may be used, or the insulative casings 124 may be omitted.

The illustrated liquid level measurement system 100 has a modular sensor design and may include any number of liquid level sensors 108. In the embodiment illustrated in FIGS. 1A and 1B, the liquid level measurement system 100 includes three liquid level sensors 108a-c: a first liquid level sensor 108a located near a bottom of the tank 104 corresponding with a first liquid level 128, a second liquid level sensor 108b located at a central portion of the tank 104 corresponding with a second liquid level 132, and a third liquid level sensor 108c located at an upper portion of the tank 104 corresponding with the maximum fill level 120. In alternate embodiments, the liquid level sensors 108a-c may be located elsewhere on the tank 104.

The illustrated liquid level sensors 108a-c and the reference sensor 116 are capacitive sensors, configured to measure a density of the tank 104 and its contents in the region each sensor. For example, each sensor 108a-c, 116 may include two spaced-apart electrodes and circuitry for selectively energizing one or both electrodes and measuring a capacitance between the electrodes. The capacitance is a function of the dielectric constant of the material between the electrodes, which includes the wall of the tank 104 and the contents of the tank 104 (i.e., liquid, air, etc.) adjacent the wall proximate the sensor 108a-c, 116. The dielectric constant changes depending on the density of the material adjacent the wall of the tank 104. As such, the liquid level sensors 108a-c are able to detect whether there is a greater density of material proximate the sensor 108a-c, indicating the presence of liquid, or a lesser density of material proximate the sensor 108a-c, indicating the liquid level of the tank is below the sensor 108. In some embodiments, the reference sensor 116, being above the maximum fill level 120, provides a reference capacitance value corresponding with a portion of the tank 104 not filled with the liquid.

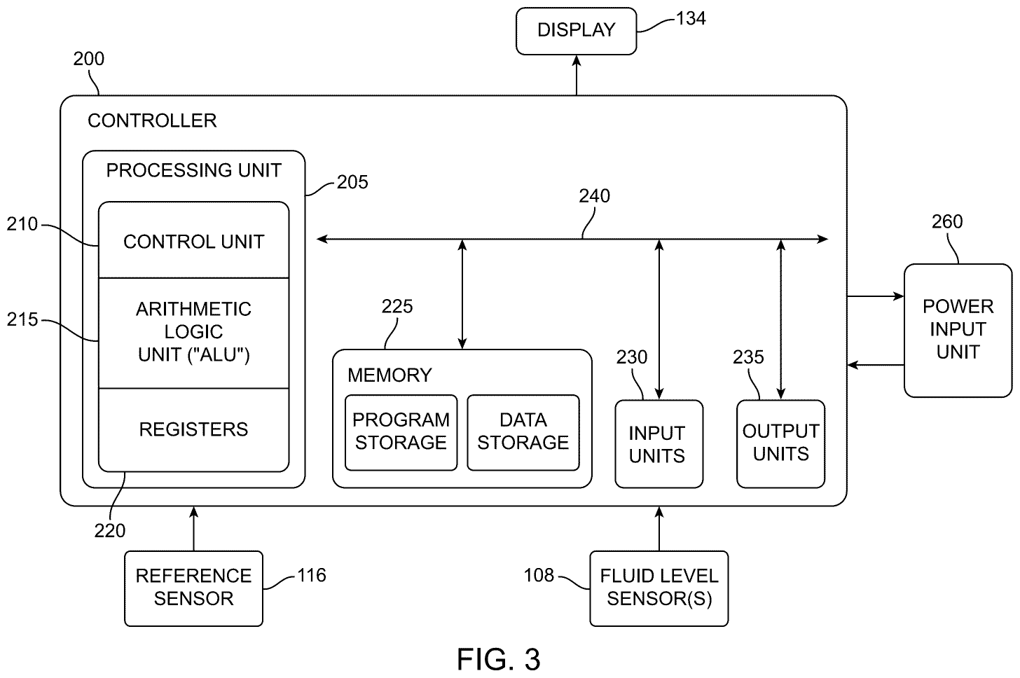

The capacitance values from the liquid level sensors 108a-c may be compared with the reference capacitance value from the reference sensor 116 to determine whether liquid is present at the level of each respective liquid level sensor 108a-c. In particular, each of the sensors 108a-c, 116 is configured to output a sensor output signal (e.g., a voltage and/or current in some embodiments) corresponding with the measured capacitance value. The sensor output signals are then received and processed by a controller 200 (FIG. 3) of the liquid level measurement system 100. In some embodiments (e.g., in which the reference sensor 116 is omitted), the capacitance values from the liquid level sensors 108a-c may be compared with a predetermined reference capacitance programmed into the sensors 108a-c or stored in the memory of the controller 200. In yet other embodiments, the controller 200 may monitor for changes in the capacitance values from the liquid level sensors 108a-c to determine whether the liquid level within the tank 104 has fallen below the positions of the respective sensors 108a-c.

In the illustrated embodiment, the liquid level sensors 108a-c and the reference sensor 116 are connected to the controller 200 via a cable 131. The cable 131 may comprise multiple segments (e.g., a first segment extending between the first sensor 108a and the second sensor 108b, a second segment extending between the second sensor 108b and the third sensor 108c, a fourth segment extending between the third sensor 108c and the reference sensor 116, and a fifth segment extending between the reference sensor 116 and the controller 200). In such embodiments, the sensors 108a-c, 116 may be daisy-chained together, simplifying assembly and connection of the sensors 108a-c, 116 and permitting a greater or lesser number of liquid level sensors 108 to be used. In such embodiments, the cable 131 may include a shared inter-integrated (I2C) channel for transmitting the sensor output signals to the controller 200. In such embodiments, each sensor 108a-c, 116 may tag its sensor output signal with a unique identifier or label corresponding with the particular sensor. Alternatively, the sensors 108a-c, 116 may be independently wired to the controller 200, or the sensors 108a-c, 116 may wirelessly communicate with the controller 200.

The controller 200 for the liquid level measurement system 100 will now be described with reference to FIG. 3. The controller 200 is electrically and/or communicatively connected to a variety of modules or components of the liquid level measurement system 100. For example, the illustrated controller 200 may be connected to the liquid level sensors 108a-c, the reference sensor 116, and a display 134 (e.g., an LED display, LCD display, gauge, or the like). In some embodiments, the controller 200 may be housed together with the display 134; however, the controller 200 may alternatively be located elsewhere on or within the liquid level measurement system 100.

The controller 200 includes a plurality of electrical and electronic components that provide power, operational control, and protection to the components and modules within the controller 200 and/or liquid level measurement system 100. For example, the controller 200 may include, among other things, a processing unit 205 (e.g., a microprocessor, an electronic processor, an electronic controller, a microcontroller, or another suitable programmable device), a memory 225, input units 230, and output units 235. The processing unit 205 may include, among other things, a control unit 210, an arithmetic logic unit (“ALU”) 215, and a plurality of registers 220 implemented using a known computer architecture (e.g., a modified Harvard architecture, a von Neumann architecture, etc.). The processing unit 205, the memory 225, the input units 230, and the output units 235, as well as the various modules connected to the controller 200, may be connected by one or more control and/or data buses.

The memory 225 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 205 is connected to the memory 225 and executes software instructions that are capable of being stored in a RAM of the memory 225 (e.g., during execution), a ROM of the memory 225 (e.g., on a generally permanent basis), or another non-transitory computer readable medium such as another memory or a disc. Software included in the implementation of the liquid level measurement system 100 can be stored in the memory 225 of the controller 200. The software includes, for example, firmware, one or more applications, program data, filters, rules, one or more program modules, and other executable instructions. The controller 200 is configured to retrieve from the memory 225 and execute, among other things, instructions related to the control processes and methods described herein. In other embodiments, the controller 200 may include additional, fewer, or different components.

The signals from the liquid level sensors 108a-c and the reference sensor 116 may pass from the input units 230, along control lines (buses) 240, and are processed by the processing unit 205, which then controls the information displayed on the display 134 via the output units 235. Thus, the controller 200 is programmed to control the display 134 based on feedback from liquid level sensors 108a-c and the reference sensor 116. The controller 200 is further connected to a power input unit 260 to regulate or control the power to and/or from the controller 200. For example, the controller 200 may provide power from the power input unit 260 to the sensors 108a-c, 116 (via the cable 131).

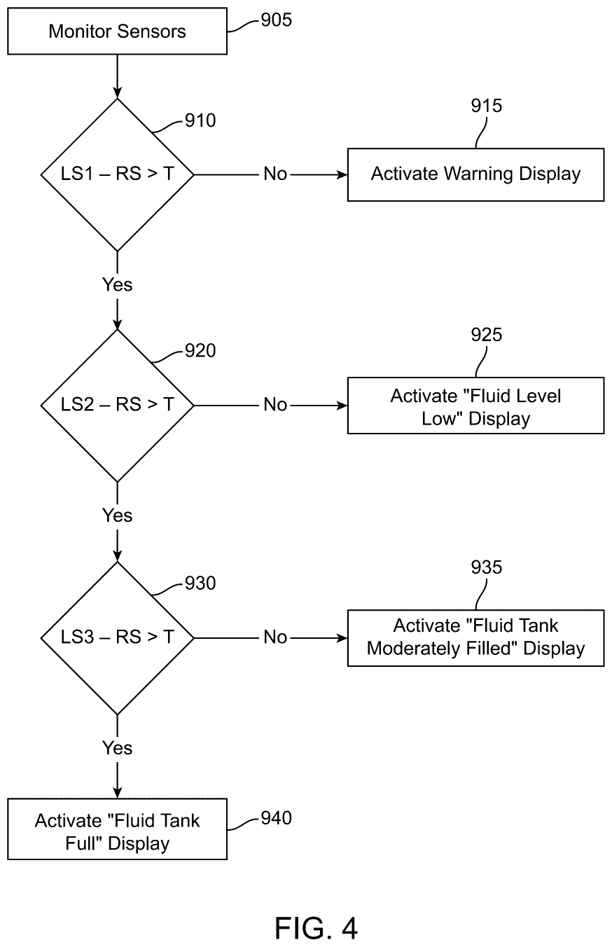

Referring to FIGS. 3-4, the controller 200 is configured to receive a sensor output signal from each connected sensor 108, 116. In the illustrated embodiment, this includes a first liquid level sensor signal LS1 from the first liquid level sensor 108a, a second liquid level sensor signal LS2 from the second liquid level sensor 108b, a third liquid level sensor signal LS3 from the third liquid level sensor 108c, and a reference signal or reference value RS from the reference sensor 116. The controller 200 is configured to compare each of the liquid level sensor signals LS1, LS2, LS3 to the reference signal RS. If the difference between a particular liquid level sensor signal LS1, LS2, LS3 and the reference signal RS is greater than a predetermined threshold value T, then the density of the tank 104 proximate the particular sensor 108a-c is greater than the density of the tank 104 proximate the reference sensor 116 (where there is no liquid present). In this way, the controller 200 is able to determine whether liquid is present at the liquid level 128, 132, 120 of each particular sensor 108a-c. By comparing the liquid level sensor signals LS1, LS2, LS3 to the reference signal RS, the liquid measurement system 100 is self-calibrating and able to be used with a wide variety of different tank materials, thicknesses, and liquids without reprogramming.

In another embodiment, the reference sensor 116 is omitted, and each of the liquid level sensor signals LS1, LS2, LS3 is compared with a reference value, which is a predetermined threshold value T programmed into the sensors 108 or controller 200. Such an embodiment may be relatively simpler and less costly than an embodiment including the reference sensor 116, and may be used, for example, when the capacitance value of the empty tank 104 is known.

In another embodiment, the liquid level sensor signals LS1, LS2, LS3 may be added together to calculate a summed output. The summed output may then be compared to a low threshold corresponding to the first liquid level 128, a medium threshold corresponding to the second liquid level 132, and a high threshold corresponding to the maximum fill level 120.

In another embodiment, the controller 200 may monitor each of the liquid level sensor signals LS1, LS2, LS3 for a change greater than a reference value in the form of a predetermined threshold value T. For example, if the sensor signal LS2 changes from X to Y, and X−Y>T, then the controller 200 determines that the level of liquid in the tank 104 has fallen below the level of the second sensor 108b.

In some embodiments, the liquid measurement system 100 may communicate with the display 134 for displaying the liquid fill level of the tank 104. For example, FIG. 2A represents a “Liquid Tank Full” display configuration 136, FIG. 2B represents a “Liquid Tank Moderately Filled” display configuration 144, and FIG. 2C represents a “Liquid Level Low” display configuration 152.

FIG. 4 illustrates an exemplary method for activating the display 134. The method may be performed automatically by the controller 200. The steps of the method are described in an iterative manner for descriptive purposes. Various steps described herein with respect to the method are capable of being executed simultaneously, in parallel, or in an order that differs from the illustrated serial and iterative manner of execution.

At step 905, the controller 200 monitors and receives signals from the liquid level sensors 108a-c and the reference sensor 116. At step 910, the controller 200 determines if the difference between the first liquid level sensor signal LS1 (corresponding with the sensor 108a) and the reference signal RS is greater than the threshold value T. NO goes to step 915, which means that the liquid level within the tank 104 is below the low liquid level 128 detectable by the sensor 108a. At step 915, the controller 200 controls the display 134 to display a warning indicating that the tank 104 almost empty. YES goes to step 920, which means that the liquid level within the tank 104 is at least at or below the low liquid level 128. At step 920, the controller 200 determines if the difference between the second liquid level sensor signal LS2 (corresponding with the sensor 108b) and the reference signal RS is greater than the threshold value T. NO goes to step 925, which means that the liquid level within the tank 104 is at or above the low liquid level 128, but below the moderate liquid level 132. At step 925, the controller 200 controls the display 134 to indicate that the tank 104 is low on liquid (the “Liquid Level Low” display configuration 152; FIG. 2C). YES goes to step 930, meaning that the liquid level within the tank 104 is at or above the moderate liquid level 132. At step 930, the controller 200 determines if the difference between the third liquid level sensor signal LS3 (corresponding with the sensor 108c) and the reference signal RS is greater than the threshold value T. NO goes to step 935, which means that the liquid level within the tank 104 is at or above the moderate liquid level 132, but below the maximum liquid level 120. At step 935, the controller 200 controls the display 134 to indicate that the tank 104 has a moderate amount of liquid (the “Liquid Tank Moderately Filled” display configuration 144; FIG. 2B). YES goes to step 940, meaning that the liquid level within the tank 104 is at the maximum fill level 120. At step 940, the controller controls the display 134 to indicate the tank 104 is full (the “Liquid Tank Full” display configuration 136; FIG. 2A).

Various features and aspects of the present disclosure are set forth in the following claims.

What is claimed is:

1. A liquid measurement system for measuring an amount of liquid within a tank, the liquid measurement system comprising:
a liquid level sensor coupled to an outside of the tank, the liquid level sensor configured to output a sensor signal; and
a controller configured to:
receive the sensor signal from the liquid level sensor, and
determine whether the liquid within the tank is at a level at or above the liquid level sensor based on the sensor signal.

2. The liquid measurement system of claim 1, further comprising a reference sensor coupled to a top portion of the tank on the outside of the tank, the reference sensor configured to output a reference signal.

3. The liquid measurement system of claim 2, wherein the controller is configured to
receive the reference signal from the reference sensor,
compare the sensor signal and the reference signal, and
determine whether the liquid within the tank is at the level at or above the liquid level sensor based on the comparison between the sensor signal and the reference signal.

4. The liquid measurement system of claim 2, wherein the liquid level sensor is one of a plurality of liquid level sensors spaced along the outside of the tank and configured to output a plurality of sensor signals.

5. The liquid measurement system of claim 4, wherein the controller is configured to receive the sensor signals from the plurality of liquid level sensors and to determine the level of the liquid within the tank by comparing each of the sensor signals with the reference signal.

6. The liquid measurement system of claim 2, the liquid level sensor is a capacitive sensor.

7. The liquid measurement system of claim 6, wherein the reference sensor is a capacitive sensor.

8. The liquid measurement system of claim 4, wherein the plurality of liquid level sensors includes three liquid level sensors.

9. The liquid measurement system of claim 4, wherein the plurality of liquid level sensors is connected to the controller in a daisy chain.

10. The liquid measurement system of claim 1, wherein the liquid level sensor includes an insulative casing extending between the tank and the liquid level sensor.

11. The liquid measurement system of claim 1, wherein the controller is configured to determine whether the liquid within the tank is at the level at or above the liquid level sensor by comparing the sensor signal with a predetermined threshold.

12. The liquid measurement system of claim 1, wherein the controller is configured to determine whether the liquid within the tank is at the level at or above the liquid level sensor by comparing a change in the sensor signal with a predetermined threshold.

13. The liquid measurement system of claim 1, further comprising a display, wherein the controller is configured to control the display to indicate the level of liquid within the tank based on the determination of whether the liquid within the tank is at the level at or above the liquid level sensor.

14. A liquid measurement system for measuring an amount of liquid within a tank, the liquid measurement system comprising:
a plurality of liquid level sensors coupled to the tank, each liquid level sensor configured to output a sensor signal corresponding with a measured capacitance of the tank at a position of the liquid level sensor; and
a controller configured to:
receive the sensor signals from the plurality of liquid level sensors,
compare each of the sensor signals with a reference value corresponding with a capacitance of an empty portion of the tank, and
determine a level of the liquid within the tank based on the comparison between the sensor signals and the reference value.

15. The liquid measurement system of claim 14, further comprising a reference sensor coupled to the tank, the reference sensor configured to output a reference signal, wherein the reference value is based on the reference signal.

16. The liquid measurement system of claim 15, wherein the reference sensor is coupled to the tank at a position above a maximum fill level of the tank.

17. The liquid measurement system of claim 14, wherein the plurality of liquid level sensors are connected in a daisy chain.

18. The liquid measurement system of claim 14, wherein the reference value is predetermined and stored in a memory of the controller.

19. The liquid measurement system of claim 14, wherein each liquid level sensor is disposed on an exterior of the tank.

20. The liquid measurement system of claim 14, further comprising a display, wherein the controller is configured to control the display to indicate the level of liquid within the tank.
